(19) United States
(12) Patent Application Publication
(10) Pub. No.: US 2007/0079830 A1
(43) Pub. Date: Apr. 12, 2007

(54) Facial viral-bacterial inhibitor mask

(76) Inventors: Albert Thomas Edwards JR., Wilmington, DE (US); Ivy Collins Edwards, Wilmington, DE (US)

Correspondence Address: Albert T. & Ivy C. Edwards, Jr., 4300 Washington Boulevard, Wilmington, DE, 19802, US

(21) Appl. No.: 11/156,979

(22) Filed: Jun. 20, 2005

(51) Int. Cl. A62B 23/02

(52) U.S. Cl. 128/205.27

(57) ABSTRACT

The present invention relates to a disposable male/female apparatus for oral infectionless sex comprising a viral-bacterial inhibitor mask for the lower face having a rectangular horizontal oriented-shaped oral cavity and a pair of opposing elastic string ear loops attached to the mask interior. The ear loops each have an accurate portion which may be grasped and stretched by a user to secure a snug fit to face. Also attached to the mask exterior is a non-latex barrier engaged and protruding therefrom by a user's lips and tongue in communication with the mask. Disposed within the outside surface of barrier is, with or without, a lubricated ribbed texture to enhance oral sex pleasure effects and a flavored lubricant that functions as a taste-bud preserver. A flexible crimp material is disposed within the inside surface to help adjust mask across bridge of nose to comply with facial features. The present invention is therefore an article to provide a safer and more convenient way to participate in infectionless oral sex when worn by a user.

### DEFINITIONS

Risk of STD/STI—the biggest risk of sexually transmitted diseases (STD) and sexually transmitted infections (STI) during oral sex are HIV, Herpes, Chlamydia, Gonorrhea, Syphilis and Hepatitis A. Both strains of herpes can live in the mouth or the genitals, and particularly during outbreaks (cold sores, herpes lesions) can be passed from one place to the other.

Oral Sex—the process of a male or female participating in oral sex involving mouth to vagina, mouth to penis, mouth to breast or mouth to anus.

Safe Oral Sex—using a barrier between the mouth and the vagina, penis or anus to avoid risks during oral sex by keeping semen, vaginal and breast fluids out of the mouth, and making sure to protect against a partner's bleeding gums, cuts, or mouth sores.

### Having a Apparatus for Infectionless Oral Sex Producing Means

Reducing the Risk of HIV Transmission Through Oral Sex

The consequences of HIV infection are life-long, life-threatening, and extremely serious. You can lower any already low risk of getting HIV from oral sex by using latex condoms each and every time. Barrier methods for use during cunnilingus and anilingus have not been evaluated. However, natural rubber latex sheets, dental dams, cut-open condoms, or plastic wrap may offer some protection from contact with body fluids and possibly reduce the risk of HIV. Because anal and vaginal sex are much riskier and because most individuals who engage in unprotected (ie. without a condom) oral sex also engage in unprotected anal and/or vaginal sex, the exact proportion of HIV infections attributable to oral sex alone is unknown, but is likely to be very small. This has led some people to believe that oral sex is completely safe. It is not. Center for Disease and Control, HIV/AIDS UPDATE, December 2000

### BACKGROUND OF THE INVENTION

Due to the alarming rate of deaths caused by the transmission of HIV'AIDS, in addition to other STI/STD, it is currently recommended to use potential allergic type latex or non-latex plastic wrap type products to act as a barrier in order to reduce the risk of becoming a victim of a STI/STD.

There is some risk for STI/STD involved in having unprotected oral sex with a man or a woman. By itself, HIV is found in blood, semen, vaginal fluids, and breast milk. A virus can be transmitted through cuts, openings, sores, and mucous membranes (mouth, anus, vagina) on the body.

To avoid risks during oral sex, it is important to keep semen and vaginal fluids out of the mouth, making sure that a partner does not have bleeding gums, cuts, or mouth sores' because the presence of blood will increase one's risk. In order to keep vaginal fluids out of the mouth, it is currently suggested to use make-shift supplies (such as plastic wrap, dental dams, cut latex gloves and condoms) as a barrier between the mouth and a partner's genitals.

These recommended products however creates slippage or fumbling, and must be held by a partner's hand(s) or otherwise obliquely supported with potential infectious items. In addition, the description of prior art exclusively relates to articles made of potential allergic and non-accenting uncomfortable latex type material. Therefore, there is currently a need for a article which comprises a comfortable non-latex material that allows hands free convenience, no slippage or fumbling for total freedom of movement and protection.

The present invention relates to a apparatus with comfort and accenting features for males and females, and more specifically a viral-bacterial inhibitor mask having an attached barrier which reduces the risk of sexually transmitted diseases and infections when worn by a user.

### DESCRIPTION OF THE PRIOR ART

There is some risk (for HIV, Herpes, Chlamydia, Gonorrhea, Syphilis, Hepatitis A) involved in having unprotected oral sex with a man or a woman. By itself, HIV is found in blood, semen, vaginal fluids, and breast milk. A virus can be transmitted through cuts, openings, sores, and mucous membranes (mouth, anus, vagina) on the body.

Furthermore, the design of existing masks for oral sex make it difficult to use, is made of a potential allergic latex material and detracts from an intimate experience. When partners participate using preventive measures, it is done during an overanxious, emotional state of mind at a moments notice. More than not, it is a preference to use non-latex protection that's esthetically pleasing, scented, light textured, lubricated, flavored or perhaps in fashionable colors, designs and logos for role-play and fore-play moments.

Although various masks for oral sex exist in the prior art, none of these articles completely satisfy the above described need, specifically since no mask for the lower face is made of a soft fabric material with a non-latex barrier as is the present invention.

For example, U.S. Pat. No. 4,815,456 issued to Rubin relates to a mask rectangular in shape made of latex that isolates exposure to the lips, mouth, and tongue of the user.

U.S. Pat. No. 4,949,731 issued to Harding relates to a mask which is a mold-injected, shaped piece of rubber or synthetic flexible material that is rigid enough to maintain at all times the shape of the human lips, the tubular oral cavity insert, and tongue protuberance, and only a small margin of isolation for the lips, mouth and tongue of the user. The mask is secured on the user's lower face by using adhesive or a stretchable elastic band.

U.S. Pat. No. 4,974,605 issued to Esquedaora relates to a mask that covers the nose, lips, mouth, tongue, cheeks and the mandible of the user, equipped with two nasal tubes for the nose in order for the user to breathe while wearing the mask.

U.S. Pat. No. 5,785,052 issued to Johnson discloses a versatile disposable film mask that's positioned under the nose of the user and ends under the user's mandible, and also covers the cheeks and chin. A disposable thin lining is available for those who are allergic to the film material. There is a top pair of primary film tying strings and two pairs of secondary film strings to hold the mask securely on the bottom portion of the user's lower face, allowing the oral cavity to open wide and close without being restricted in the process.

These four protective masks are exclusively designed and constructed in latex material having limited freedom of tongue movement. The above described articles have several disadvantages. The patent issued to: Rubin and Harding isolates only the lips, mouth and tongue while the patents issued to Esquedaora and Johnson both isolates the lips, tongue, mouth, cheeks and mandible, but differ as the Esquedaora mask covers the nose equipped with two nasal tubes for the nose in order for the user to breathe while wearing the mask, and the patent issued to Johnson covers the chin area. The prior art does not allow the masks to operate in response to the essential oral cavity movements because of the latex material, and does not adjust to various face sixes.

Finally, the above described are not integral with the facial viral-bacterial inhibitor apparatus mask. The present invention overcomes these disadvantages by constructing a mask made of a soft fabric material for a user to easily breathe through, that yields readily to the size and movement of the lower face, having an attached non-latex infectionless barrier producing means received therein which automatically provides protection and stimulation upon the user wearing the mask and pushing tongue through rectangular horizontal oriented-shaped oral cavity.

### SUMMARY OF THE INVENTION

The present invention relates to a male/female apparatus for oral infectionless sex comprising a viral-bacterial inhibitor mask for the lower face having a rectangular horizontal oriented-shaped oral cavity and a pair of opposing elastic string ear loops attached to the mask interior. The ear loops each have an accurate portion which may be grasped and stretched by a user. Also attached to the mask exterior is a non-latex barrier engaged and protruding therefrom by a user's lips and tongue in communication with the mask. Disposed within the outside surface of barrier is a lubricated ribbed texture to enhance oral sex pleasure effects. The lubricant is of the type generally known and disposed within the accurate portion that functions as a condom. When a user protrudes the accurate portion of the present invention barrier, the user's mouth temperature will cause comfort and stimulation to the partner. Disposed within the inside surface of barrier is a flavored lubricant that functions as a taste-bud preserver. A flexible crimp material is disposed within the inside surface to help adjust mask across bridge of nose to comply with facial features. The present invention is therefore an article to provide a safer and more convenient way to participate in infectionless oral sex when worn by a user.

It is yet another article of the present invention to provide a facial viral-bacterial inhibitor mask with a non-latex plastic film barrier resistant to oxygen, water, acids, bases and solvents to protect against bacteria, body fluids, bleeding gums, cuts, or mouth sores when worn.

It is yet another article of the present invention to provide a facial viral-bacterial inhibitor mask in a soft fabric producing a means for easy breathing and to keep moisture off the skin to allow the body to regulate its own temperature, made to lift and support for a secure snug fit, hands free convenience, no slippage or fumbling and total freedom of movement. Other articles, features and advantages of the present invention will become readily apparent from the following detailed description of the preferred embodiment when considered with the attached drawings and the appended claims.

### BRIEF DESCRIPTION OF THE DRAWINGS

FIG. 1 depicts the inventive article outside surface.

FIG. 2 depicts the inventive article interior surface.

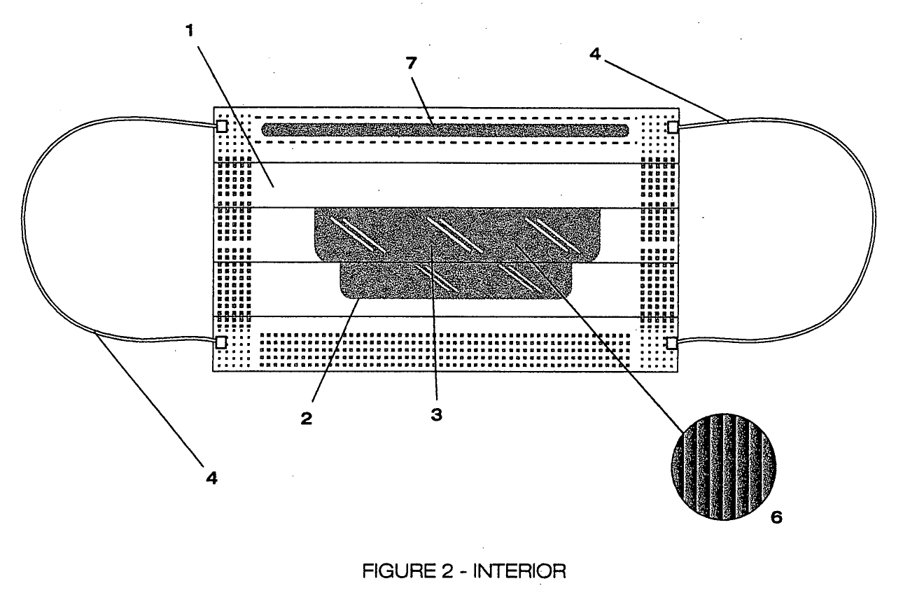

FIG. 3 depicts the inventive article with the components disposed therein in isometric form.

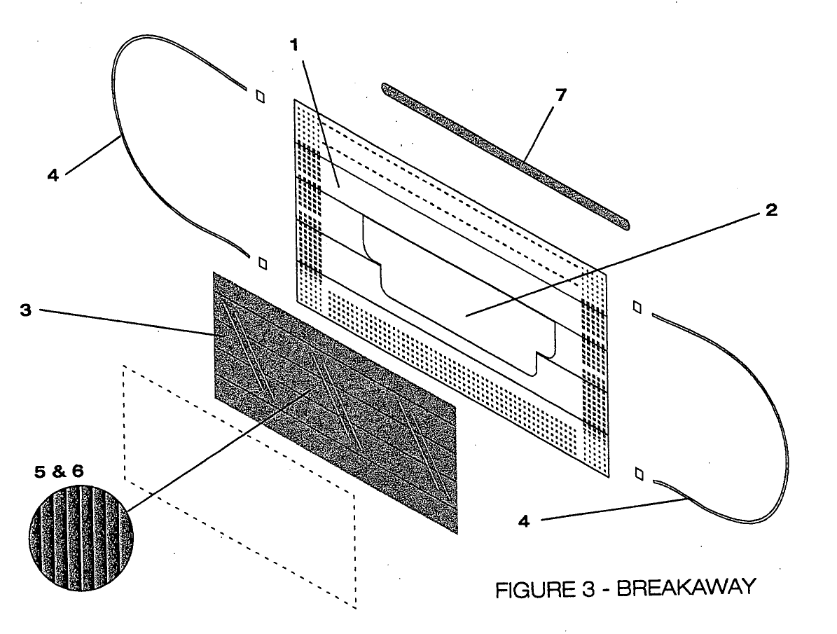

### DESCRIPTION OF THE PREFERRED EMBODIMENT

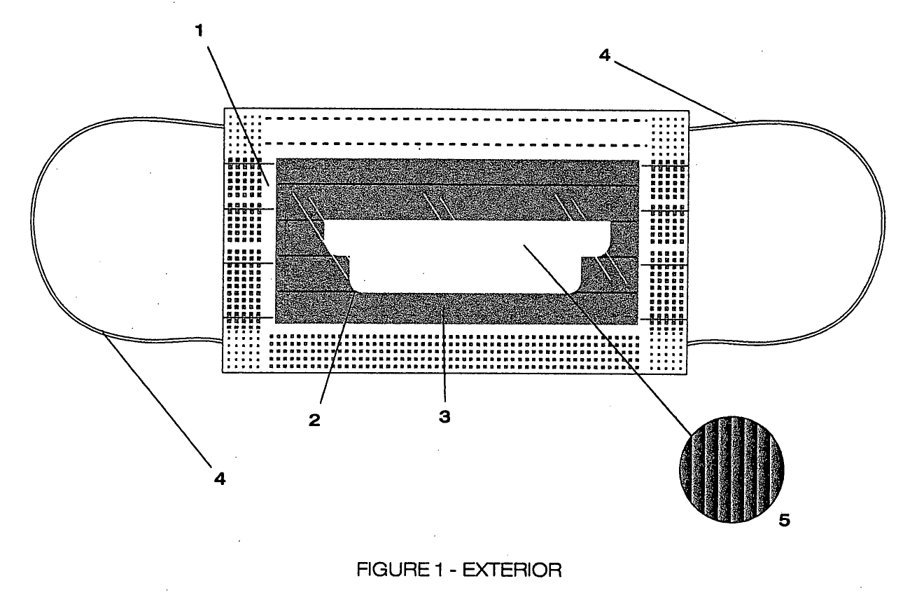

Referring now to FIG. 1, 2 and 3, the present invention relates to a female/male gender apparatus for infectionless oral sex producing means. It comprises a (1) facial viral-bacterial inhibitor apparatus mask having a (2) rectangular horizontal oriented-shaped oral cavity enclosable with an (3) attached non-latex plastic film barrier engaged and protruding therefrom by a user's lips and tongue in communication with the mask exterior. A pair of (4) opposing elastic string ear loops are attached to the mask interior, each having an accurate portion which may be grasped and stretched by a user. Disposed within the outside surface of barrier is (5) a lubricated ribbed texture to enhance oral sex pleasure effects. Disposed within the inside surface of barrier is (6) a flavored lubricant that functions as a taste-bud preserver. Disposed within the interior surface of the mask is (7) a flexible crimp amterial to help adjust mask across bridge of nose to comply with facial features of user.

The facial viral-bacterial inhibitor mask is dimensioned to yield readily to various lower face sizes and movements, comprised generally of folded pleats of the fabric material receiving within corner borders slots to attach the elastic U-shaped ear loops to the mask interior.

The above described article is not to be limited to the exact details of construction enumerated above. The mask and barrier are preferably manufactured with a soft fabric and plastic film materials respectively, or suitable equivalents. The textured and flavored lubricants are of the type generally known in the use of condoms and therefore are not shown and described in significant detail.

Although there has been shown and described the preferred embodiments of the present invention, it will be readily apparent to those skilled in the art that modifications may be made thereto which do mot exceed the scope of the appended claims. Therefore, the scope of the invention is only to be limited by the following claims.

What is claimed is:

1. A facial viral-bacterial inhibitor mask comprising:
a) a fabric material substantially rectangular in shape having an exterior surface and interior surface consisting of a soft fabric material with multiple pleats yielding readily to the size and movement of the lower face.
b) a pair of opposing elastic string ear loops to adjust and secure mask to face, each having an accurate portion which may be grasped and stretched by a user.

2. A facial viral-bacterial inhibitor mask according to claim 1 further comprising:
a) a barrier to reduce risk and exposure to sexually transmitted diseases and sexually transmitted infections through contact with bacteria, body fluids, bleeding gums, cuts, or mouth sores.

3. A facial viral-bacterial inhibitor mask according to claim 2 wherein said means for effective protection comprises:
a) a non-latex plastic film barrier resistant to oxygen, water, acids, bases and solvents to protect against bacteria, body fluids, bleeding gums, cuts, or mouth sores when worn.

4. A facial viral-bacterial inhibitor apparatus mask according to claim 3 further comprising:
a) a barrier of light textured moisture resistant plastic film material to prevent vaginal fluids and semen from entering the mouth, thereby reducing exposure to bleeding gums, cuts, or mouth sores of a user
b) a barrier to protect the mouth, hands, vagina, penis, anus, breast and sex toys from any sexually transmitted infections (STIs) or diseases (STDs).
c) a barrier made of non-latex transparent plastic film that's preferably esthetically pleasing

5. A facial viral-bacterial inhibitor apparatus mask according to claim 1 further comprising:
a) with or without, a lubricant and ribbed texture generally known for enhancing pleasure sensation effects disposed within the outside surface of barrier, the user's mouth temperature causing comfort and stimulation of the partner.
b) with or without, a lubricant generally known for taste-bud preserving effects disposed within the inside surface of barrier, to preserve a user's taste bud when having oral sex.

6. A facial viral-bacterial inhibitor apparatus mask according to claim 1 further comprising:
a) a male/female mask to be used as an apparatus for oral sex from mouth to vagina, mouth to penis, mouth to breast or mouth to anus.

7. A facial viral-bacterial inhibitor apparatus mask according to claim 1 further comprising:
a) a generally plenary body portion with multiple folded pleats having an interior surface and outer surface defined by a upper border and a lower border made of a soft fabric material, with elastic string each connecting to said upper corner borders and lower corner borders
b) a soft fabric material dimensioned to yield readily to various lower face sizes and movements, comprised generally of folded pleats of the fabric material, and barrier attached within one or more exterior folded pleats;
c) a soft fabric material having portions which fits snugly over the nose, mouth, cheeks, chin and mandible of a user to protect the lower face from bacteria, body fluids, said member dimensioned in shape having a top cuffed border with flexible crimp material which fits above the nose and extends to the ear, a bottom cuffed border which fits below the chin and extends to the mandible, and having a cuffed rectangular horizontal oriented-shaped oral cavity surrounding a user's mouth extending from above top lip to below the chin.
d) a cuffed rectangular horizontal oriented-shaped oral cavity border member which have means that is enclosable with an attached non-latex barrier engaged and protruding therefrom by a user's lips and tongue in communication with the mask exterior.
e) a cuffed rectangular horizontal oriented-shaped oral cavity border member for attached enclosable non-latex barrier to protrude outwardly or inwardly to accommodate a tongue or penis.

8. A facial viral-bacterial inhibitor apparatus mask according to claim 7 further comprising:
a) a soft fabric producing a means for easy breathing and to keep moisture off the skin to allow the body to regulate its own temperature,
b) a mask to lift and support for a secure snug fit, hands free convenience, no slippage or fumbling and total freedom of movement.
c) a safer and more convenient way to participate in infectionless oral activity when worn by a user.

9. A facial viral-bacterial inhibitor mask according to claim 8 wherein said means for effective protection comprises:
a) a mask that's preferably esthetically pleasing, scented, or perhaps in fashionable colors, designs and logos for role/fore-play moments.
b) a barrier that's transparent and light textured, with or without pleats, providing an accenting feature, preserving the natural look, feel and total freedom of movement of a user's lips and tongue on known or unknown sensitive areas.
c) a mask with an intimate appearance and responds to required movements, improving body awareness and feedback.
d) a mask that provides confidence for body presentation and psychological readiness, and more comfort for better performance.
e) a mask that allows air to circulate for better ventilation and hygienic effect.
